(19) United States
(12) Patent Application Publication
(10) Pub. No.: US 2010/0092183 A1
(43) Pub. Date: Apr. 15, 2010

(54) FREQUENCY TUNABLE TERAHERTZ CONTINUOUS WAVE GENERATOR

(75) Inventors: Sungil Kim, Daejeon (KR); Kwang Yong Kang, Daejeon (KR); Mun Cheol Paek, Daejeon (KR); Sang Kuk Choi, Daejeon (KR); Min Hwan Kwak, Daejeon (KR); Han Cheol Ryu, Gyeonggi-do (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/495,640

(22) Filed: Jun. 30, 2009

(30) Foreign Application Priority Data
Oct. 10, 2008 (KR) 10-2008-0099664

(51) Int. Cl. H04B 10/04

(52) U.S. Cl. 398/183

(57) ABSTRACT

A frequency tunable terahertz continuous wave generator controls the number of feedbacks of an optical signal output from an optical intensity modulator by adding a feedback loop between input and output terminals of the optical intensity modulator, thereby simply tuning a frequency of a terahertz continuous wave.

### CROSS-REFERENCE TO RELATED APPLICATION

This application claims priority to and the benefit of Korean Patent Application No. 10-2008-0099664, filed Oct. 10, 2008, the disclosure of which is incorporated herein by reference in its entirety.

### BACKGROUND

1. Field of the Invention

The present invention relates to a frequency tunable terahertz continuous wave generator, and more particularly, to a frequency tunable terahertz continuous wave generator that can easily tune a frequency with low phase noise and high frequency stability.

2. Discussion of Related Art

With the development of information communication and video technology, transmission capacity required for a communication network is rapidly increasing and hence interest in broadband wireless communication is remarkably increasing.

However, since currently allocated frequency resources are in a saturation state, research is aimed at broadband communication systems stably operable in a millimeter-wave band (mm-wave band) or terahertz band (THz band) greater than a microwave band.

As one of these broadband communication systems, a millimeter-wave generator for generating an optical signal in a millimeter-wave band using a Gunn diode has been disclosed. The millimeter-wave generator may be manufactured in an existing compound semiconductor process. However, there is a problem in that the millimeter-wave generator has high phase noise at a normal temperature and is limited to a tunable frequency range of about 100 GHz.

Accordingly, active research is aimed at a photomixing system that is able to generate an optical signal of at least the millimeter-wave band with low phase noise that is not sensitive to an operation environment, including factors of temperature, humidity, etc.

The photomixing system generates a terahertz wave corresponding to a wavelength difference between two optical signals by beating the two optical signals with different wavelengths and has excellent frequency tuning performance. However, the photomixing system has a problem in that the two optical signals of the different wavelengths should maintain polarization with a correlation to each other.

As described above, a terahertz continuous wave generator using the photomixing system generally outputs an optical signal with a fixed wavelength from one light source, outputs an optical signal with a tunable wavelength from the other light source, and generates a terahertz wave by beating the optical signals with the two different wavelengths.

The terahertz continuous wave generator using the two light sources as described above has a broadband characteristic in that a tunable frequency range is several tens of THz. However, the terahertz continuous wave generator using the two light sources has problems in that the optical signals of the two different wavelengths are not correlated to each other, frequency drift is serious, and phase noise is high.

Accordingly, active research is aimed at an apparatus for outputting optical signals with different wavelengths from a single light source and generating a terahertz wave by beating the optical signals.

A terahertz continuous wave generator using a single light source generates a terahertz continuous wave using a mode locking laser method, a dual mode laser method, an injection locking method, a Double-sideband-Suppressed Carrier (DSB-SC) signal generation method, or a frequency comb method.

It is difficult to manufacture an optical device using the mode locking method or the dual mode method. There is a problem in that a product using the mode locking method or the dual mode method may not be widely used due to a high development cost. It is difficult to widely use the injection locking method because a locking process should be performed in order to acquire a desired frequency and operation conditions are complex.

The frequency comb method has excellent frequency tuning performance, but requires an expensive optical intensity modulator and Arrayed Waveguide Grating (AWG).

As a type of optical heterodyne system, the DSB-SC signal generation method may be simply configured and easily acquire an optical signal of a desired frequency as compared with the other methods. Accordingly, a large amount of research is aimed at the DSB-SC signal generation method. However, since the DSB-SC signal generation method should vary a modulated signal frequency to tune an optical signal frequency, there is a problem in that an applicable modulated signal frequency is limited by an operating bandwidth of an optical intensity modulator and hence frequency-tuning performance is limited.

Since the terahertz continuous wave generator using the single light source generates optical signals with different wavelengths from the single light source, the correlation between two beat optical signals increases, the phase noise decreases, and the frequency stability increases. However, it is difficult to easily tune a frequency in the terahertz continuous wave generator.

### SUMMARY OF THE INVENTION

The present invention provides a terahertz continuous wave generator that can easily tune a frequency with low phase noise and high frequency stability.

According to an aspect of the present invention, a frequency tunable terahertz continuous wave generator includes: an optical signal generator that generates a double-sideband optical signal by modulating an optical signal with a single wavelength output from a single light source in a DSB-SC scheme, feeds back and modulates the double-sideband signal n times (where n is an integer of at least 1) in the DSB-SC scheme, and generates two optical signals with different wavelengths by selectively removing an unnecessary optical signal from among multiple double-sideband optical signals generated by feeding back the double-sideband optical signal; and an optical signal converter that performs conversion into a terahertz continuous wave by photomixing the two optical signals with the different wavelengths generated by the optical signal generator.

The optical signal generator may include: a Radio Frequency (RF) local oscillator that generates an RF continuous signal; an optical intensity modulator that generates the double-sideband optical signal by modulating the optical signal with the single wavelength in the DSB-SC scheme using the RF continuous signal generated by the RF local oscillator and generates the multiple double-sideband optical signals by feeding back and modulating the double-sideband optical signal n times in the DSB-SC scheme; first and second circulators that are connected to input and output terminals of the optical intensity modulator and feed back the double-sideband optical signal; a tunable notch filter that selectively removes the unnecessary optical signal from among the multiple double-sideband optical signals generated by feeding back the double-sideband optical signal; and a notch width controller that controls a notch width of the tunable notch filter.

Frequency bands of the two optical signals output from the tunable notch filter may be varied by controlling the number of feedbacks of the double-sideband optical signal and the notch width of the tunable notch filter.

The optical signal generator may include: a plurality of couplers that distribute the optical signal with the single wavelength output from the light source; an RF local oscillator that generates an RF continuous signal; a plurality of optical intensity modulators, each generating the double-sideband optical signal by modulating the distributed optical signal with the single wavelength in the DSB-SC scheme using the RF continuous signal generated by the RF local oscillator and generating the multiple double-sideband optical signals by re-modulating the fed-back double-sideband optical signal in the DSB-SC scheme; first and second circulators that are connected to input and output terminals of the optical intensity modulators and feed back the double-sideband optical signal; a plurality of FBG type notch filters, each connected to an output terminal of each optical intensity modulator and selectively removing the unnecessary optical signal from among the multiple double-sideband optical signals generated by feeding back the double-sideband optical signal; and an optical switch that selects one of the double-sideband optical signals output from the notch filters.

A frequency may be tunable by selecting the double-sideband optical signal through the optical switch.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of a frequency tunable terahertz continuous wave generator according to a first exemplary embodiment of the present invention;

FIGS. 2A to 2C are diagrams illustrating an operation of the frequency tunable terahertz continuous wave generator according to the present invention; and

FIG. 3 is a block diagram of a frequency tunable terahertz continuous wave generator according to a second exemplary embodiment of the present invention.

### DETAILED DESCRIPTION OF EXEMPLARY EMBODIMENTS

A frequency tunable terahertz continuous wave generator according to exemplary embodiments of the present invention will be described in detail herein below with reference to the accompanying drawings.

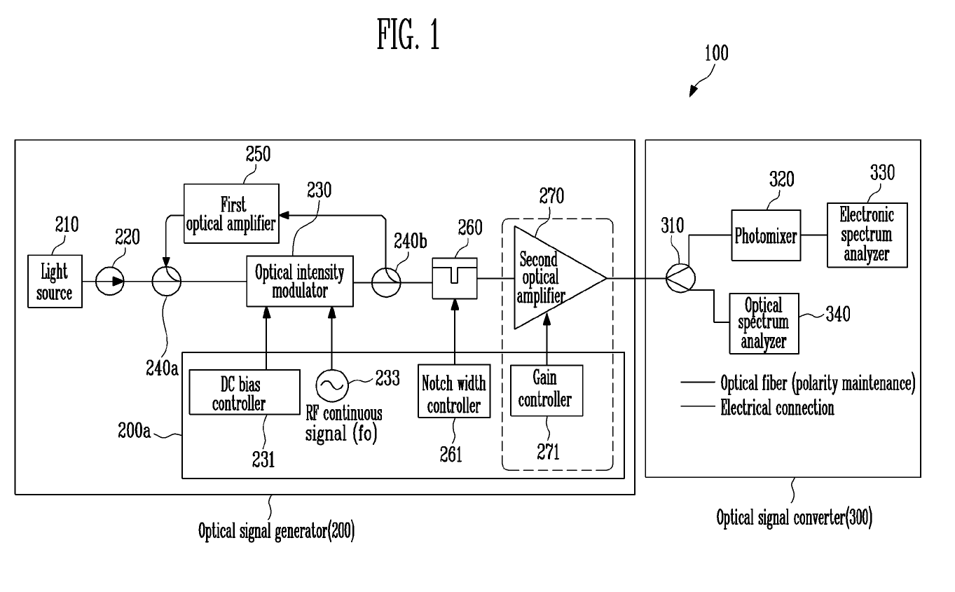

FIG. 1 is a block diagram of a frequency tunable terahertz continuous wave generator according to a first exemplary embodiment of the present invention.

Referring to FIG. 1, a frequency tunable terahertz continuous wave generator 100 according to the first exemplary embodiment of the present invention includes an optical signal generator 200 for generating two optical signals with different wavelengths correlated to each other and an optical signal converter 300 for performing conversion into a terahertz continuous wave by photomixing the two optical signals generated by the optical signal generator 200.

The optical signal generator 200 includes a single light source 210 for outputting an optical signal with a single wavelength, an isolator 220 for preventing the optical signal output by the light source 210 from being reflected to the light source 210, an optical intensity modulator 230 for generating a double-sideband optical signal using the optical signal output from the light source 210, first and second circulators 240a and 240b for feeding back the optical signal output from the optical intensity modulator 230, a first optical amplifier 250 for amplifying the optical signal fed back from the optical intensity modulator 230, a Fiber Bragg Grating (FBG) type tunable notch filter 260 for selectively removing an unnecessary optical signal from among multiple double-sideband optical signals generated by optical signal feedbacks, and an electronic controller 200a for controlling operations of the optical intensity modulator 230 and the tunable notch filter 260.

The electronic controller 200a includes a Direct Current (DC) bias controller 231 for controlling DC bias magnitude of the optical intensity modulator 230, an RF local oscillator 233 for generating and outputting an RF continuous signal to the optical intensity modulator 230, and a notch width controller 261 for controlling a notch width of the tunable notch filter 260.

The optical signal generator 200 may further include a second amplifier 270 for amplifying an optical signal output from the tunable notch filter 260. In this case, the electronic controller 200a may further include a gain controller 271 for controlling a gain of the second amplifier 270.

The optical signal converter 300 includes a coupler 310 for receiving and distributing the two optical signals with the different wavelengths from the optical signal generator 200, a photomixer 320 for performing conversion into a terahertz continuous wave signal by mixing the two optical signals distributed by the coupler 310, an electronic spectrum analyzer 330 for analyzing an electronic spectrum of the terahertz continuous wave signal output from the photomixer 320, and an optical spectrum analyzer 340 for analyzing optical spectra of the two optical signals distributed by the coupler 310.

Here, the electronic spectrum analyzer 330 is used to check a frequency of the terahertz continuous wave signal. If needed, a terahertz-wave radio communication system may be implemented by connecting a terahertz-wave antenna to the photomixer 320 in place of the electronic spectrum analyzer 330.

In this exemplary embodiment, the light source 210 may be a laser diode capable of generating an optical signal with a single wavelength of a narrow bandwidth (100 KHz).

The first optical amplifier 250 may be implemented with an optical amplifier with a noise index less than or equal to 6 dB and a gain of about 5 dB. The second optical amplifier 270 may be implemented with an optical amplifier with a noise index less than or equal to 6 dB and a gain of about 30 dB.

The optical intensity modulator 230 may appropriately use a modulator with a bandwidth of at least 60 GHz to generate a terahertz wave of at least 0.1 THz, but may have a desired bandwidth by controlling the number of optical signal feedbacks using a modulator with a bandwidth less than or equal to 40 GHz. This will be described below in detail.

The notch width controller 261 may vary a notch width from 0.3 nm to 8 nm.

The frequency tunable terahertz continuous wave generator according to the exemplary embodiment of the present invention configured as described above can generate a terahertz continuous wave with a frequency band from 0.1 THz to 1 THz. This will be described below in detail.

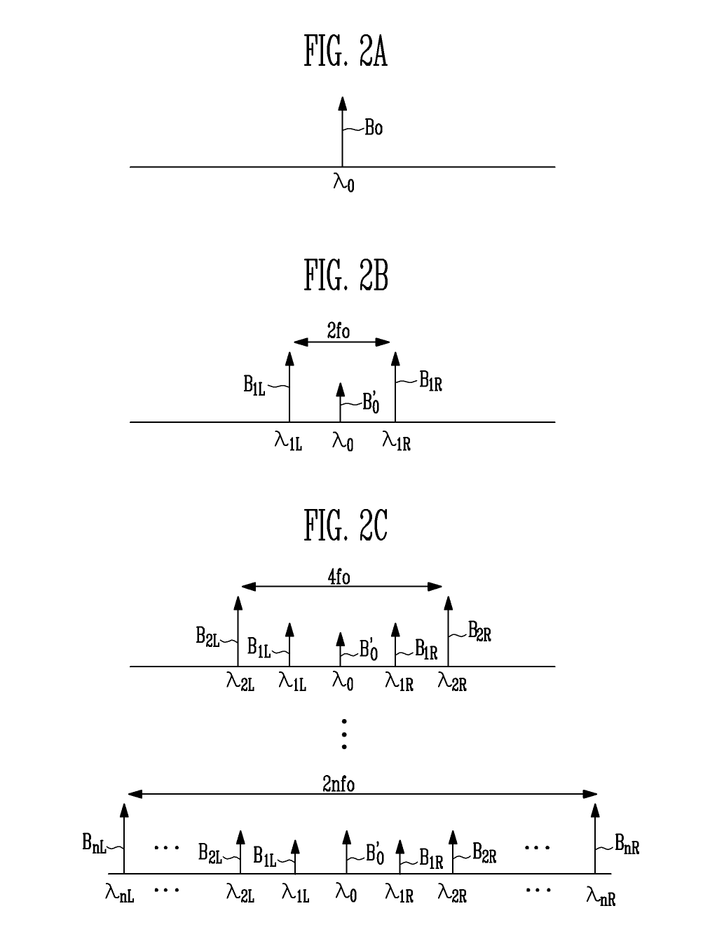

FIGS. 2A to 2C are diagrams illustrating an operation of the frequency tunable terahertz continuous wave generator according to an exemplary embodiment of the present invention.

First, referring to FIG. 2A, when the light source 210 generates an optical signal B₀ with a single wavelength λ₀, the optical signal B₀ with the single wavelength is input to the optical intensity modulator 230 through the isolator 220 and the first circulator 240a.

Next, referring to FIG. 2B, the optical intensity modulator 230 suppresses the intensity of an optical carrier by controlling the magnitude of the optical signal B₀ with the single wavelength according to the DC bias magnitude input from the DC bias controller 231. Using the RF continuous signal generated by the RF local oscillator 233, the optical signal B₀ with the single wavelength is modulated in a DSB-SC scheme.

Double-sideband optical signals B₀′, B_{1L}, and B_{1R} in which the optical carrier has been suppressed are generated at positions respectively separated by a frequency f₀ of the RF continuous signal with respect to the center of the optical signal B₀ with the single wavelength.

When the double-sideband optical signals B₀′, B_{1L}, and B_{1R} in which the optical carrier has been suppressed are generated through the above process, the tunable notch filer 260 filters and outputs the suppressed optical carrier B₀′.

The photomixer 320 outputs a signal with a frequency of 2f₀ by photoelectrically converting the double-sideband optical signals B_{1L} and B_{1R}. Here, the signal output from the photomixer 320 is a continuous signal of a terahertz-wave band.

The above process is the same as the conventional DSB-SC signal generation method.

The conventional DSB-SC signal generation method should vary a frequency f₀ of an RF continuous signal generated by the RF local oscillator 233 in order to tune a frequency of a signal output from the photomixer 320. Accordingly, a frequency of an applicable RF continuous signal is limited by an operating bandwidth of the optical intensity modulator 230 and hence frequency-tuning performance is limited.

On the other hand, the present invention is characterized in that a frequency is tunable in a simple structure by adding a feedback loop between input and output terminals of the optical intensity modulator 230. This will be described in detail as follows.

Referring to FIG. 2C, when a signal with a terahertz frequency f_{T} of 2nf₀ (where n is the number of feedbacks) is generated, 2nf₀ can be expressed as shown in Equation 1.

2nf₀=|f_{nL}−f_{nR}≡f_{T}(THz) (Equation 1)

Here, f₀ denotes the frequency of an RF continuous signal generated by the RF local oscillator 233 and f_{nL} and f_{nR} denote the frequencies of left and right sideband components among double-sideband frequencies DSB-SC modulated by the optical intensity modulator 230, respectively.

Since f_{nL}>f_{nR} and λ_{nL}<λ_{nR}, C=f_{nL}λ_{nL}=f_{nR}λ_{nR}.

When n=1, a difference Sᵢ between λ_{nL} and λ_{nR} caused by the frequency f₀ of the RF continuous signal generated by the RF local oscillator 233 can be expressed as shown in Equation 2.

$${S}_{i} ( nm ) = \frac{2 \cdot {f}_{0} \cdot {λ}_{C} \cdot C}{{C}^{2} - {f}_{0}^{2} \cdot {λ}_{C}^{2}} \qquad ( Equation 2 )$$

Here, λ_{C} denotes the wavelength of the optical carrier input from the light source 210 to the optical intensity modulator 230.

When n=1, a notch width N_{W} and a design margin M_{W} can be expressed as shown in Equation 3.

$${M}_{W} = \frac{{S}_{i} - {N}_{W}}{2} \qquad ( Equation 3 )$$

Using Equation 3, a difference S_{W} between wavelengths of two double-sideband optical signals B_{nL} and B_{nR} can be expressed as shown in Equation 4 when the number of feedbacks is n.

S_{W}(nm)=Sᵢ·n (Equation 4)

The wavelengths λ_{nL} and λ_{nR} of the two double-sideband optical signals B_{nL} and B_{nR} can be expressed as shown in Equation 5.

$${λ}_{nL} ( nm ) = {λ}_{C} - \frac{{S}_{W}}{2} \\ {λ}_{nR} ( nm ) = {λ}_{C} + \frac{{S}_{W}}{2} \qquad ( Equation 5 )$$

When the number of feedbacks is n, a notch width W_{N} of the tunable notch filter 260 can be expressed as shown in Equation 6.

$$\begin{matrix}\begin{matrix}{W}_{N} ( nm ) = {λ}_{nR} - {λ}_{nL} - 2 \cdot {M}_{W} \\ = {S}_{W} - 2 \cdot {M}_{W}\end{matrix} & ( Equation 6 )\end{matrix}$$

Using Equations 1 to 6, a frequency tuning operation of the frequency tunable terahertz continuous wave generator 100 according to an exemplary embodiment of the present invention will be described in detail.

Referring again to FIG. 1, when two double-sideband optical signals B_{1L} and B_{1R} (see FIG. 2B) output from the optical intensity modulator 230 are input to the FBG type tunable notch filter 260 through the second circulator 240b, the two double-sideband optical signals B_{1L} and B_{1R} are reflected from the FBG type tunable notch filter 260 to the second circulator 240b.

The two double-sideband optical signals B_{1L} and B_{1R} reflected to the second circulator 240b are amplified by the first optical amplifier 250 and reflected to the optical intensity modulator 230 through the first circulator 240a.

Using an RF continuous signal generated by the RF local oscillator 233, the optical intensity modulator 230 modulates the two double-sideband optical signals B_{1L} and B_{1R} in the DSB-SC scheme.

As shown in FIG. 2C, other double-sideband optical signals B_{2L} and B_{2R} are generated at positions respectively separated by a frequency f₀ of the RF continuous signal from the two double-sideband optical signals B_{1L} and B_{1R}.

When the two double-sideband optical signals B_{1L} and B_{1R} output from the optical intensity modulator 230 are fed back n times in the above scheme, double-sideband optical signals B_{nL}, B_{(n-1)L}, - - - , B_{1L} B_{1R}, B_{2R}, - - - , B_{nR} are generated at positions respectively separated by a multiple of n of the frequency f₀ of the RF continuous signal with respect to the center of the optical signal B₀ with the single wavelength in which the optical carrier has been suppressed as shown in FIG. 2C.

Until the double-sideband optical signals B_{nL} and B_{nR} with terahertz frequencies f_{nL} and f_{nR} corresponding to a notch width are input to the tunable notch filter 260, the double-sideband optical signals are reflected. When the double-sideband optical signals B_{nL} and B_{nR} with the terahertz frequencies f_{nL} and f_{nR} corresponding to the notch width are input, they are input to the photomixer 320 by removing components other than wavelengths λ_{nL} and λ_{nR}. Accordingly, the photomixer 320 outputs a terahertz continuous wave with a frequency of 2nf₀.

When the number of reflections from the tunable notch filter 260 is adjusted by controlling the notch width of the tunable notch filter 260 in a state in which an oscillation frequency of the RF local oscillator 233 is set, a terahertz continuous wave of a desired frequency band can be generated simply by controlling the number of feedbacks of the optical signal output from the optical intensity modulator 230.

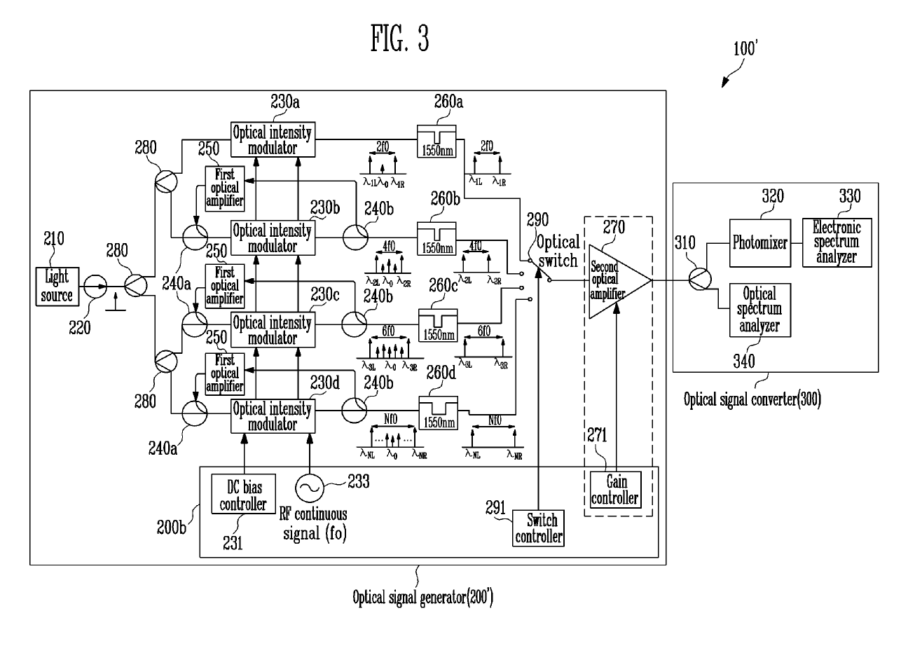

FIG. 3 is a block diagram of a frequency tunable terahertz continuous wave generator according to a second exemplary embodiment of the present invention.

Referring to FIG. 3, in a frequency tunable terahertz continuous wave generator 100′ according to a second exemplary embodiment of the present invention, an optical signal generated by a light source 210 is input to a plurality of optical intensity modulators 230a, 230b, 230c, and 230d through a coupler 280. The optical intensity modulators 230a, 230b, 230c, and 230d output double-sideband optical signals of various frequency bands.

Here, a feedback loop is not added to the optical intensity modulator 230a of a first stage since the optical intensity modulator 230a generates an optical signal with a frequency of at least 0.1 THz when an RF local oscillator 233 generates an RF continuous signal of at least 50 GHz.

Output terminals of the optical intensity modulators 230a, 230b, 230c, and 230d are connected to notch filters 260a, 260b, 260c, and 260d each having a notch width based on a predetermined frequency. Accordingly, the notch filters 260a, 260b, 260c, and 260d output optical signals with different band frequencies 2f₀, 4f₀, 6f₀, and 8f₀.

When a switch controller 291 selects one of the double-sideband optical signals output from the notch filters 260a, 260b, 260c, and 260d by controlling an optical switch 290, the selected double-sideband optical signal is input to a photomixer 320, such that a terahertz continuous wave with a corresponding frequency is generated and a frequency tuning operation is performed by selecting the double-sideband optical signal through the optical switch 290.

Here, the number of notch filters and a type of optical switch may be changed according to a frequency tunable region of a terahertz continuous wave signal to be generated.

A frequency tunable terahertz continuous wave generator according to an exemplary embodiment of the present invention can generate a terahertz continuous wave with low phase noise and excellent frequency stability using a DSB-SC scheme.

A frequency tunable terahertz continuous wave generator according to an exemplary embodiment of the present invention can control the number of feedbacks of an optical signal output from an optical intensity modulator by adding a feedback loop between input and output terminals of the optical intensity modulator, thereby simply generating a terahertz continuous wave of a desired frequency band and easily tuning a frequency.

A frequency tunable terahertz continuous wave generator according to an exemplary embodiment of the present invention can easily tune a frequency with low phase noise and excellent frequency stability and can be used as a core device of an ultra high-speed ultra-broadband radio communication system.

While the present invention has been shown and described in connection with exemplary embodiments thereof, it will be apparent to those skilled in the art that various modifications can be made without departing from the spirit and scope of the invention as defined by the appended claims.

What is claimed is:

1. A frequency tunable terahertz continuous wave generator comprising:
an optical signal generator that generates a double-sideband optical signal by modulating an optical signal with a single wavelength output from a single light source in a Double-sideband-Suppressed Carrier (DSB-SC) scheme, feeds back and modulates the double-sideband signal n times (where n is an integer of at least 1) in the DSB-SC scheme, and generates two optical signals with different wavelengths by selectively removing an unnecessary optical signal from among multiple double-sideband optical signals generated by feeding back the double-sideband optical signal; and
an optical signal converter that performs conversion into a terahertz continuous wave by photomixing the two optical signals with the different wavelengths generated by the optical signal generator.

2. The frequency tunable terahertz continuous wave generator of claim 1, wherein the optical signal generator comprises:
a Radio Frequency (RF) local oscillator that generates an RF continuous signal;
an optical intensity modulator that generates the double-sideband optical signal by modulating the optical signal with the single wavelength in the DSB-SC scheme using the RF continuous signal generated by the RF local oscillator and generates the multiple double-sideband optical signals by feeding back and modulating the double-sideband optical signal n times in the DSB-SC scheme;
first and second circulators that are connected to input and output terminals of the optical intensity modulator and feed back the double-sideband optical signal;
a tunable notch filter that selectively removes the unnecessary optical signal from among the multiple double-sideband optical signals generated by feeding back the double-sideband optical signal; and
a notch width controller that controls a notch width of the tunable notch filter.

3. The frequency tunable terahertz continuous wave generator of claim 2, wherein the optical intensity modulator suppresses an intensity of an optical carrier by controlling an intensity of the optical signal with the single wavelength according to Direct Current (DC) bias magnitude.

4. The frequency tunable terahertz continuous wave generator of claim 2, wherein the notch width controller varies the notch width of the tunable notch filter from 0.3 nm to 8 nm.

5. The frequency tunable terahertz continuous wave generator of claim 2, wherein the tunable notch filer has a Fiber Bragg Grating (FBG) type.

6. The frequency tunable terahertz continuous wave generator of claim 2, wherein frequency bands of the two optical signals output from the tunable notch filter are varied by controlling the number of feedbacks of the double-sideband optical signal and the notch width of the tunable notch filter.

7. The frequency tunable terahertz continuous wave generator of claim 2, wherein the optical signal generator further comprises:
a first optical amplifier that amplifies the double-sideband optical signal fed back from the optical intensity modulator; and
a second optical amplifier that amplifies the two optical signals with the different wavelengths output from the tunable notch filter.

8. The frequency tunable terahertz continuous wave generator of claim 1, wherein the optical signal converter comprises:
a photomixer that mixes the two optical signals with the different wavelengths generated by the optical signal generator.

9. The frequency tunable terahertz continuous wave generator of claim 8, wherein an output terminal of the photomixer is connected to an electronic spectrum analyzer or a terahertz wave antenna.

10. The frequency tunable terahertz continuous wave generator of claim 2, wherein when the number of feedbacks of the double-sideband optical signal is n, the notch width of the tunable notch filter is computed by:
$$\begin{matrix}{W}_{N} ( nm ) = {λ}_{nR} - {λ}_{nL} - 2 \cdot {M}_{W} \\ = {S}_{W} - 2 \cdot {M}_{W} ,\end{matrix}$$
where λ_{nL} and λ_{nR} denote wavelengths of left and right sideband components of an n^{th} DSB-SC modulated double-sideband optical signal, M_{W} denotes a notch width when the number of feedbacks of the double-sideband optical signal is 1, and S_{W} denotes a difference between the wavelengths of the left and right sideband components of the n^{th} DSB-SC modulated double-sideband optical signal.

11. The frequency tunable terahertz continuous wave generator of claim 1, wherein the optical signal generator comprises:
a plurality of couplers that distribute the optical signal with the single wavelength output from the light source;
an RF local oscillator that generates an RF continuous signal;
a plurality of optical intensity modulators, each generating the double-sideband optical signal by modulating the distributed optical signal with the single wavelength in the DSB-SC scheme using the RF continuous signal generated by the RF local oscillator and generating the multiple double-sideband optical signals by re-modulating the fed-back double-sideband optical signal in the DSB-SC scheme;
first and second circulators that are connected to input and output terminals of the optical intensity modulators and feed back the double-sideband optical signal;
a plurality of FBG type notch filters, each connected to an output terminal of each optical intensity modulator and selectively removing the unnecessary optical signal from among the multiple double-sideband optical signals generated by feeding back the double-sideband optical signal; and
an optical switch that selects one of the double-sideband optical signals output from the notch filters.

12. The frequency tunable terahertz continuous wave generator of claim 11, wherein a frequency is tunable by selecting the double-sideband optical signal through the optical switch.
